(19) United States
(12) Patent Application Publication
(10) Pub. No.: US 2012/0103876 A1
(43) Pub. Date: May 3, 2012

(54) Sand Sifter

(75) Inventor: John C. Allaire, Rosenburg, TX (US)

(73) Assignee: RB ENVIRONMENTAL, L.L.C., Houston, TX (US)

(21) Appl. No.: 12/912,975

(22) Filed: Oct. 27, 2010

(51) Int. Cl. B07B 1/28; B07B 1/46

(52) U.S. Cl. 209/235

(57) ABSTRACT

The present invention is directed to a method and a vehicle designed for cleaning beaches that have been contaminated with substances such as tar balls. The device utilizes an inclined screen assembly on a vehicle and a pivoted hopper supported below the lower end of the inclined screen. As the trailer is on or moved along the beach, contaminated sand is placed on an upper portion of the screen. Sand falls through the screen back down to the beach surface but larger contaminants such as tar balls roll or slide down the screen into a collection hopper. The inclination of the screen assembly may be adjustable.

BACKGROUND OF INVENTION

1. Field of the Invention

The invention described in this application relates to a mobile beach sand sifting device that is designed to remove waste material from beach sand and deposit the waste material in a suitable receptacle, while returning the sand to the beach surface. The device may also be used in any environment where it is necessary to separate coarse material from a mass of finer particulate material. A method of removing contaminants from sand on a beach is also disclosed.

2. Description of Related Art

Recent events have demonstrated the need for mobile beach-cleaning apparatus in the situation where an oil spill has occurred at sea. Semi-solid accumulations of oil known as tar balls wash up on beaches and need to be picked up and separated from the sand in an efficient manner.

Known devices for cleaning sand on beaches tend to be large self-propelled vehicles such as that disclosed in U.S. Pat. No. 5,197,211. These units are very expensive, tend to require frequent maintenance and are not very maneuverable. Smaller units such as disclosed in U.S. Pat. No. 7,156,236 are more portable but are also far more complex and consequently more expensive than the current invention. They are also more prone to maintenance issues because they include complex mechanical subassemblies. They are also not particularly effective in picking up tar balls due to the nature of the sifting mechanisms.

### BRIEF SUMMARY OF THE INVENTION

The invention disclosed and claimed in this application overcomes the above noted deficiencies by utilizing a compact, maneuverable, and far less complex design. It includes a mobile frame supported by wheels. A towing arm is positioned at a front portion of the frame to form a trailer for attachment to a motorized vehicle. An inclined screen is supported on the frame. A hinged hopper is provided at the lower portion of the screen to collect larger bodies such as tar balls that have been separated out. The hopper can then be tilted to direct tar balls or other bodies into plastic bags for transportation to a treating facility.

### BRIEF DESCRIPTION OF THE SEVERAL VIEWS OF THE DRAWING(S)

FIG. 1 is a perspective view of the sifter according to an embodiment of the invention.

FIG. 2 is a side view of the sifter shown in FIG. 1.

FIG. 3 is a top view of the sifter shown in FIG. 1.

FIG. 4 is a perspective view of a record embodiment of the invention.

FIG. 5 is a side view of the embodiment of FIG. 4.

FIG. 6 is a top view of the embodiment of FIG. 4.

FIG. 7 is a partial perspective view of the L-shaped frame members.

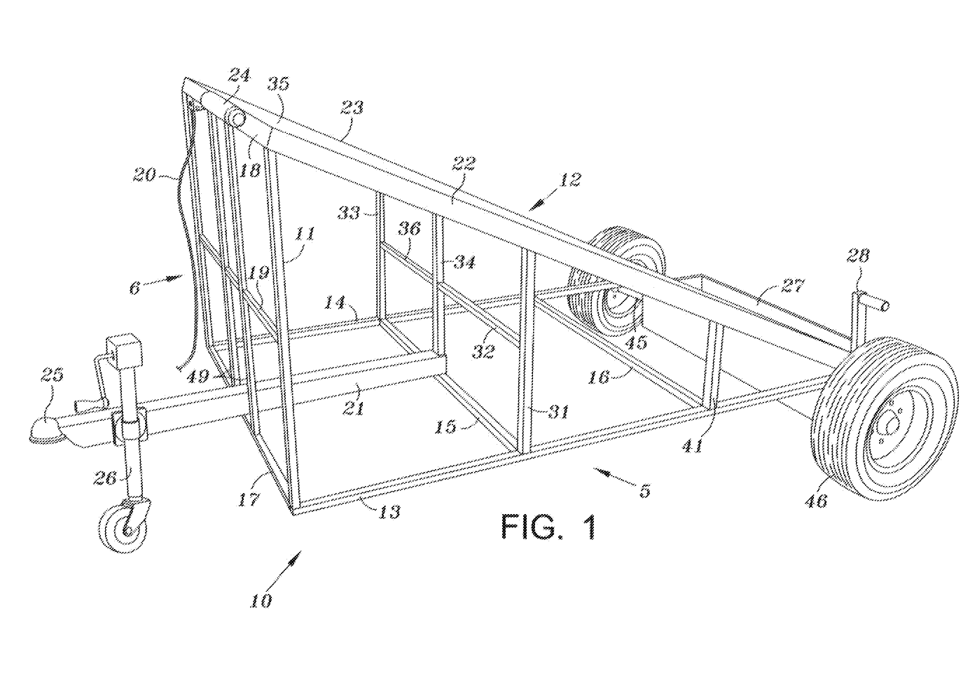

FIGS. 1-3 illustrate an embodiment of the invention. However it should be understood that this embodiment is one of many constructions that would occur to one with ordinary skill in the art. The particular frame structure and hopper construction can be varied as is known in the art. Similarly, the manner of attaching the sifter to a four wheel utility vehicle is not critical but can be accomplished in any one of the several known hitch arrangements for trailers.

### DETAILED DESCRIPTION OF THE INVENTION

Referring to FIG. 1, an embodiment of sifter 10 of the invention includes a first generally horizontal frame member 5, a second generally vertical frame member 6 extending upwardly from the front portion of frame member 5 and a slanted or inclined frame member 12 sloping from the top of vertical frame member to the rear end portion of frame member 5. Inclined frame member 12 supports a rectangular screen 35 secured to a frame in a known manner. The framed screen may be replaced by providing suitable releasable securing means between the inclined frame 12 and the screen frame.

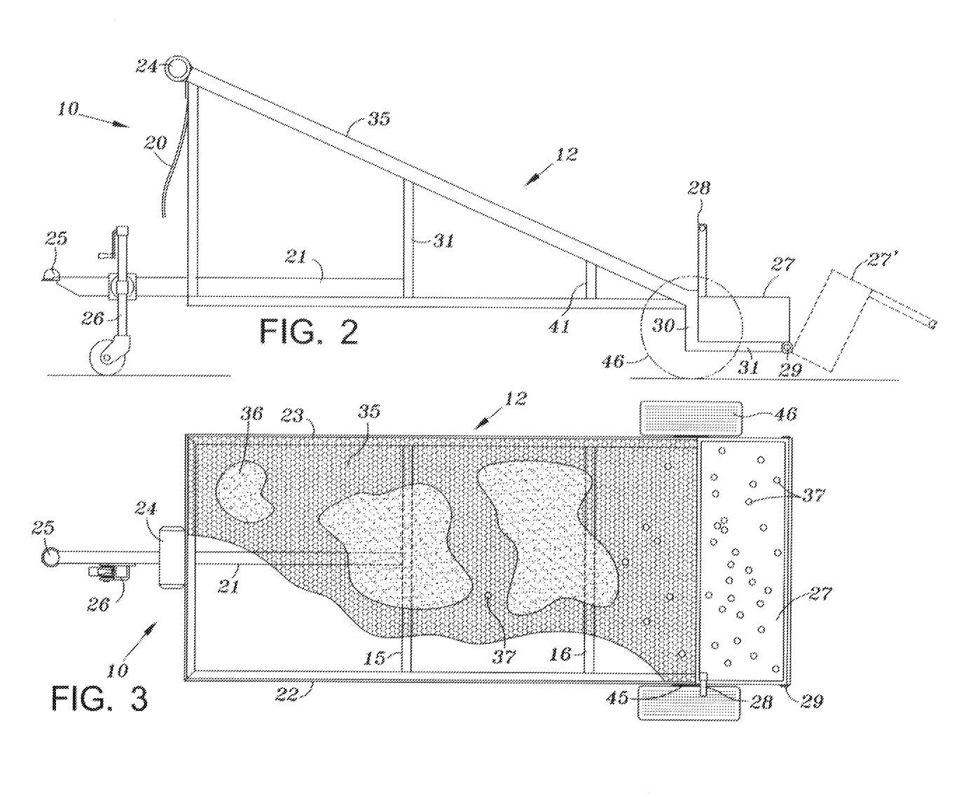

Sifter 10 may include side rails 14, 13 and transverse rails 15, 16, and 17. Referring to FIG. 2, at the rear portion of sifter 10 two L-shaped brackets 30 are provided to pivotably support a hopper 27 positioned slightly below the rear portion of screen 35. Hopper 27 is hinged at its rear portion on both sides to member 31 of the L-shaped brackets 30. Handle 28 is attached to hopper 27 so that hopper 27 can be pivoted about pivot 29 to discharge its contents. Supports (not shown) extending between the brackets 30 and 31 may be provided for supporting hopper 27.

Sifter 10 also includes two wheels 46 that are pivotably mounted to the frame in any known manner such as an axle or spindle 45 supported by the frame. Towing arm 21 is secured to the front portion of horizontal frame 10 as shown in FIG. 1. Coupling device 25 of any known design is positioned on the towing arm for allowing the sifter to be releasably connected to a suitable towing vehicle. The front end of the tow bar may also be provided with a height adjustable wheel assembly 26 that is connected to the draw bar in a known fashion.

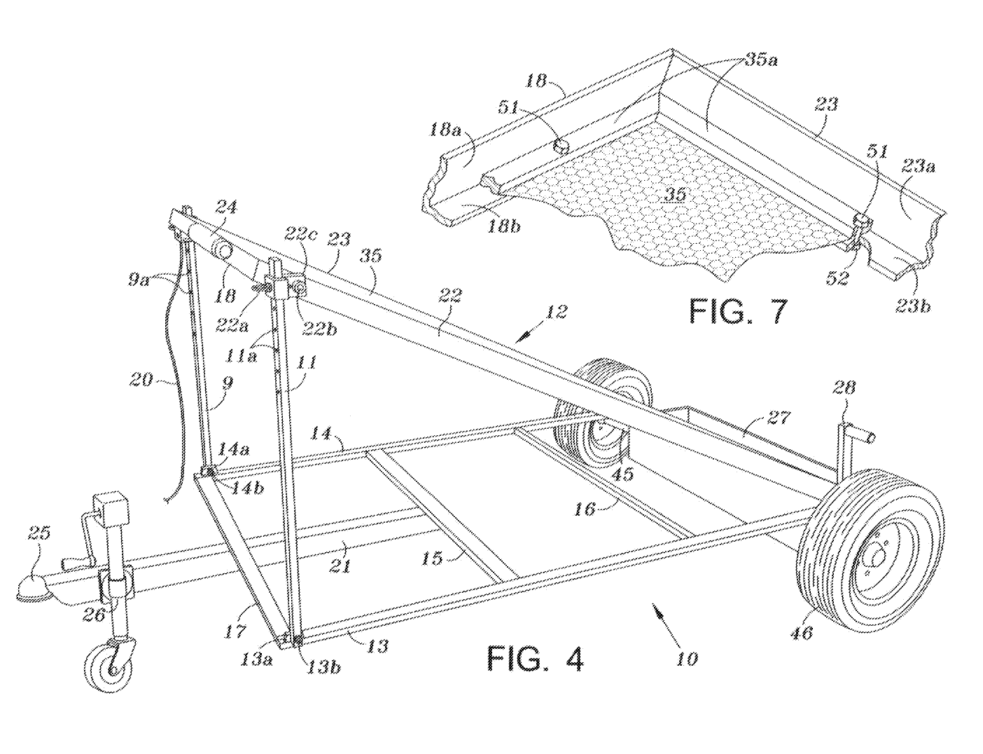

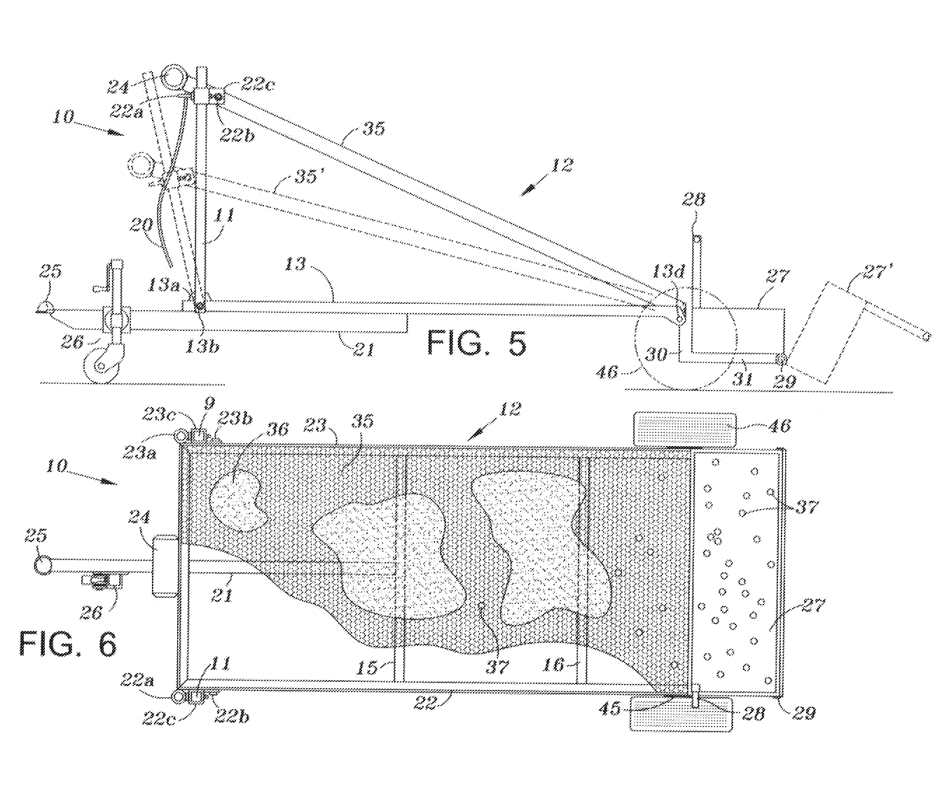

Vertical frame 11 includes a plurality of upright rails 49 and cross rail 19. Inclined frame member 12 includes two side rails 22 and 23 and upper cross member 18 that form a frame for supporting screen assembly 35. Intermediate cross member may also extend between rails 22 and 23 to support the screen assembly. A twelve volt vibrator 24 is attached to the overall frame structure at any suitable location so as to vibrate screen assembly 35, thereby facilitating separation of the material placed on the top of the screen. A power cable 20 extends from vibrator 24 and may be connected to a twelve volt power source on the towing vehicle. Supporting rails 31, 33, 34 and 41 may further be provided to support the inclined frame 12 on the horizontal frame 10. The various rail components as described above can be welded to each other to form a rigid assembly, or otherwise secured to each other in any known fashion. FIGS. 4-6 illustrate a second embodiment of the invention which includes structure for adjusting the inclination of the screen. The same reference numbers have been used for similar elements in the drawings.

In this embodiment lower frame 5 includes longitudinal beams 13, 14 and cross beams 15, 16 and 17. A towing bar 21 extends between cross beams 15 and 17 and has a suitable coupling 25 for attachment to a power vehicle. Vertically adjustable wheel assembly 26 is attached to a forward portion of the towing bar 21. Two vertical posts 9 and 11 are pivotally mounted at their lower end to longitudinal beams 13 and 14 by pivot assemblies 13a, 13b and 14a, 14b respectively. Inclined frame assembly 12 includes 2 L-shaped longitudinal members 22 and 23 and a front L-shaped cross member 18.

Members 22, 23 and 18 form a frame that is adapted to hold the screen and screen frame assembly in place. The screen frame may be releasably secured to the inwardly extending portion of the L-shaped frame members 22 and 23 by any suitable means such as a nut and bolt assembly passing through apertures in the L-shaped member and the screen frame as shown in FIG. 7.

A pair of bracket members 22c and 23c are pivotably connected to the forward ends of longitudal frame members 23, 22 at 22b and 23c. Bracket members 22c and 23c include a rectangular collar that slidably receives vertical frame members 9 and 11 and are perforated to receive locking pins 22a and 23a. The rear portions of members 22 and 23 are pivoted to base frame members 13, 14 at 13d and 14d.

The inclination of the screen assembly can be adjusted by removing pins 22a and 23a and sliding brackets 22c and 23c up or down on the support posts 9 and 11. Support posts 9 and 11 include a plurality of holes 9a and 11a that can receive pin 22a.

FIG. 7 illustrates the L-shaped frame members 18 and 23 including the vertical section 18a and 23a and the horizontal sections 18b and 23b that support screen and screen frame 35 and 35a. Screen frame 35a is removably attached to L-shaped members 23 and 23 by any suitable means such as a plurality of nuts 51 and bolts 52.

The above described apparatus may be used to clean up any contaminants that are present on beaches, but is particularly useful for cleanup of tar balls that are deposited on beaches as a result of oil spills. In use, the sifter is attached to the towing vehicle at coupling 25. The sifter is positioned on the beach or is slowly driven on the beach as contaminated sand is placed on the top portion of the screen assembly, either by workers (walking alongside the sifter) or by a front loader that has scooped up the sand and contaminants. As shown in FIG. 3 the sand moves down the screen assembly and due to gravity it falls through the screen back onto the beach 36 but the tar balls 37 roll or slide down the screen into the hopper 27. The hopper can then be tilted so that the tar balls can be transferred to plastic bags for easy collection. The apparatus increases the productivity of manual cleanup crews because instead of bagging the sand for disposal in a dumpster, the sand placed on the screen returns directly to the beach and only the tar balls need to be hauled away.

Various modifications to the device can be made as would be apparent to one with ordinary skill in the art. More than one screen assembly with screens of varying mesh size can be utilized. Also, in lieu of a screen, a perforated thin metal sheet may serve as the filtering element.

It is understood that modifications to the invention may be made as might occur to one skilled in the field of the invention within the scope of the appended claims. All embodiments contemplated hereunder which achieve the objects of the invention have not been shown in complete detail. Other embodiments may be developed without departing from the spirit of the invention or from the scope of the appended claims. Although the present invention has been described with respect to specific details, it is not intended that such details should be regarded as limitations on the scope of the invention, except to the extent that they are included in the accompanying claims.

I claim:

1. A trailer for removing contaminants from sand in a beach comprising:
a generally horizontal frame;
a generally vertical frame;
a inclined frame extending between an upper portion of the vertical frame and a rear portion of the horizontal frame;
a filtering assembly positioned on the inclined frame;
a trailer coupling on the front portion of the horizontal frame, wheels, supporting the trailer; and
a hopper connected to a rear portion of the trailer below the lower portion of the filtering assembly to collect contaminants that have been separated from the sand.

2. A trailer as claimed in claim 1 further including a vibrator coupled to a frame member.

3. A trailer according to claim 1 wherein the hopper is pivotably mounted to a frame member for rotation about a horizontal axis.

4. A trailer according to claim 3 further including a handle attached to the hopper for facilitating rotation of the hopper.

5. A trailer as claimed in claim 1 wherein the inclined frame is pivotably mounted so that the angle of inclination may be varied.

6. A trailer as claimed in claims 5 wherein the inclined frame is pivotably connected at its lower end to the base frame,
the generally vertical frame comprises two upright posts each pivoted connected to the forward portion of the generally horizontal frame at their lower ends,
a pair of collars pivotably connected to the included frame at upper portion of the included frame and including a sleeve portion that slidably receives the upright posts; and
apertures in the vertical posts and in the collars adapted to receive a pin for screen adjusting the angle of inclination of the filtering medicine.

7. A trailer as claimed in claim 1 wherein the filtering assembly is a screen mounted to a frame.

8. A trailer as claimed in claim 1 wherein the filtering assembly is a thin sheet of perforated metal.

9. A method of removing contaminants from sand on a beach comprising:
providing a trailer having an inclined frame supporting a filtering assembly; and a hopper on the trailer located below the filtering assembly;
placing the trailer on a beach having contaminated sand;
placing the contaminated sand on an inclined portion of the filtering assembly and allowing the sand to move downwardly and through the filtering assembly thereby falling down onto the beach surface; and
collecting contaminants that are larger in size than the sand by allowing the contaminants to proceed down the inclined filtering assembly into the hopper.

10. The method of claim 9 further including the step of vibrating the inclined frame.

11. The method of claim 9 further including the step of varying the inclination of the inclined frame.

12. The method of claim 9 wherein the hopper is pivotably mounted on the vehicle and further including the step of pivoting the hopper to discharge the separated contaminants into bags for removal.

13. The method of claim 9 including the step of moving the trailer along the beach as the sand is placed on the screen.
